(19) United States
(12) Patent Application Publication
(10) Pub. No.: US 2025/0103887 A1
(43) Pub. Date: Mar. 27, 2025

(54) COMPUTATIONAL EFFICIENT CONVOLUTIONAL NEURAL NETWORK

(71) Applicant: Robert Bosch GmbH, Stuttgart (DE)

(72) Inventors: Lukas Meiner, Weissach (DE); Alexandru Paul Condurache, Renningen (DE); Jens Eric Markus Mehnert, Malmsheim (DE)

(21) Appl. No.: 18/883,102

(22) Filed: Sep. 12, 2024

(30) Foreign Application Priority Data
Sep. 22, 2023 (DE) 10 2023 209 280.8

(51) Int. Cl. G06N 3/082; G06N 3/0464

(52) U.S. Cl. CPC G06N 3/082; G06N 3/0464

(57) ABSTRACT

A computer-implemented method for a computer-implemented method of efficiently calculating convolution operations. The method includes receiving a tensor of input data to be proceeded and at least one filter and initializing a locality-sensitive hashing function. Then, repeating the following steps for each patch in the tensor: Slicing the current receptive field into a series of matrices. Applying the locality-sensitive hashing to each of said matrices to determine a hash representation for each matrix. Merging the matrixes with essentially the same hash representation to a new matrix. Creating a reduced tensor by arrange the merged matrices in a series. Merging the filter coefficients in the same order as the matrices have been merged and convolving the merged on the reduced sub-tensor with the merged filter.

### CROSS REFERENCE

The present application claims the benefit under 35 U.S.C. § 119 of German Patent Application No. DE 10 2023 209 280.8 filed on Sep. 22, 2023, which is expressly incorporated herein by reference in its entirety.

### FIELD

The present invention concerns a method of efficiently calculating convolutions via locality-sensitive hashing, and a computer program and a machine-readable storage medium and a training system.

### BACKGROUND INFORMATION

Reducing the computational cost of convolutional neural network architectures (CNNs) for their application in an autonomous driving scenario as image classifiers or semantic segmentation backbones is important for high computational performance.

For reducing said computational cost, described in the literature is for example the approach of “Dynamic Dual Gating Neural Networks” by Fanrong Li et al. (available online:

openaccess.thecvf.com/content/ICCV2021/papers/Li_Dynamic_Dual_Gating_Neural Networks_ICCV_2021_paper.pdf). The authors employ a trainable method to find redundancies in the spatial and channel dimension of a convolutional module during training of the underlying CNN. After the training procedure, their method can be used to dynamically reduce computational cost dependent on the input image. This is done by generating spatial and channel masks from the trained additional parameters, effectively hiding redundant information from the convolution operation to reduce (theoretical) computational cost.

Other methods like “Pruning Filters for Efficient ConvNets” by Hao Li et al. (available online: arxiv.org/pdf/1608.08710.pdf) prune the filters of CNNs. This can happen after training by employing some metrics (like L2-norm of filters) to determine whether a filter/channel can be pruned safely, i.e., without harming accuracy/model performance much. However, these methods require a fine-tuning step after pruning to restore lost accuracy.

The conventional approaches are either not parameter-free by requiring a specialized training procedure (e.g., generating masks as seen in Dynamic Dual Gating Neural Networks) or not training-free (e.g., requiring a fine-tuning step after the pruning step). This means that existing, trained models either need to be entirely retrained from scratch or at least fine-tuned for the pruning approaches to be viable (accuracy/FLOPs trade-off). This results in a variety of problems. Firstly, the requirement for retraining or fine-tuning incurs increased energy and time consumption. Secondly, the fine-tuning step may result in catastrophic forgetting, where the model drastically loses performance on the task it was originally trained on, especially when fine-tuning on dissimilar data to that used in training. Lastly, the requirement for additional training creates a dependency on the availability of the dataset that was used to train the underlying CNN.

The present invention removes these restrictions, as it does not require any fine-tuning or retraining step and is entirely parameter-free and data-free. Therefore, it can act as a plug and play replacement for convolutional modules in CNN architectures, directly reducing computational cost in the form of FLOPs (floating-point operations, that can be e.g. interpolated from the number of multiply-accumulate operations, MACs).

### SUMMARY

The present invention relates to a method of structured pruning, or more concretely, a method of channel pruning. More precisely, the inventors propose a convolution module based on locality sensitive hashing (LSH) that can act as a plug and play replacement for any regular convolution module, instantly reducing the FLOPs during inference. Thereby, the present invention lifts restrictive requirements for being able to reduce the computational complexity of CNNs, such as the requirement for retraining and/or fine-tuning or pruned models and training data dependencies. It offers a plug-and-play pruning solution to instantly reduce the FLOPs in CNN architectures, whereas prior art requires time-consuming retraining or fine-tuning steps.

In a first aspect of the present invention, a method of efficiently calculating 2- or 3-dimensional convolution operations in, e.g., a 3-dimensional tensor is proposed. The computation efficiency is achieved by means of dynamically decreasing the number of channels in parts of said tensor individually. Preferably, the method is applied for a convolutional layer of a neural network.

According to an example embodiment of the present invention, the method starts with a step of receiving a tensor (X∈R^{c}^{ᵢₙ}^{×h×w}) of input data to be proceeded in particular by the convolutional layer and at least one filter (Fⱼ∈R^{c}^{ᵢₙ}^{×k×k}, j∈{1, 2, . . . , cₒᵤₜ}) in particular of the convolutional layer and initializing a locality-sensitive hashing function. It is noted that the order of the steps “Receiving” and “Initializing” can be arbitrarily changed. The hashing function can remain unchanged after initialization. The filter is preferably a 2 or 3-dimensional filter comprising a plurality (cᵢₙ) of 2-dimensional filter kernels (k×k) that are arranged in a series along a third dimension. The number of 2- or 3-dimensional kernels can be the same number of matrices which the tensor comprises along at least one of its dimensions, e.g. the number of 2-dimensional kernels cᵢₙ equals the number of arranged matrices cᵢₙ of the tensor. It is noted that the merging of the matrices described below is then carried out along the dimension of the tensor which equals with the number of kernels of the filter.

Then, a loop follows, wherein in said loop the following steps are repeated for a plurality of 3 dimensional patches X^{(p)}∈R^{c}^{ᵢₙ}^{×(k+b)×(k+b)} of the tensor. A 3-dimensional patch refers to a specified sub-tensor of said input tensor. Patches are chosen to be of size (k+b×k+b) with for example b=2 and keep and overlap of two pixels/units to the neighbor along a second and third dimension of said tensor, wherein along a first dimension the patches have the same size as said tensor. The second and third dimension can be referred to as spatial dimension. Taking a patch from said tensor is equivalent to tiling the input along the spatial dimension into regions of size (k×k), while keeping the overlap necessary for the convolution operation with kernels of size (k×k). In other words, along the second and third dimension of the tensor, the patches are cut out of the tensor. It is noted that the second and third dimension of the tensor span matrices. The first dimension of the tensor can be seen as the dimension in which the matrices are lined up, wherein the different matrices along the first dimension can be referred to as channels or slides. Thus the number of channels of the patch are identical to the number of channels of the tensor. It is noted that said concept can be also extended to a 3-dimensional filter, wherein then the patches of the tensor is then a sub-tensor of said tensor.

The first step of the loop comprises a step of slicing the current patch along the first dimension, into a series (cᵢₙ) of matrices (k+b×k+b). It follows then a step of applying the locality-sensitive hashing to each of said matrices to determine a hash representation for each matrix. It follows then a step of merging the matrices with essentially the same hash representation to a new matrix. Under the term ‘essentially’, it can be understood that slightly different hash representations are assigned to the same hash bucket, that are defined by a predefined number of hyperplanes. It follows then a step of creating a reduced tensor (c_{in,reduced}×k+b×k+b) by arranging the merged matrices in a series, particularly such that the two-dimensional matrices lie face-to-face behind the other to obtain the three-dimensional reduced tensor. It follows then a step of merging along the dimension cᵢₙ of the filter kernels in the same order as the matrices have been merged. In general, each filter kernel, in particular each kernel (k×k), at a given position in the filter along the dimension cᵢₙ of the filter is applied to the matrix at the same position along the dimension cᵢₙ of the sub tensor while carrying out the convolution. If at least two matrices at given positions are merged, the corresponding filter kernels at the same positions in the filter are merged analogically, in particular summed up. In other words, the corresponding kernels of the merged matrices are merged.

It follows then a step of convolving the reduced sub-tensor with the merged filter. It is noted that for the step of convolving, the convolution is then carried out by sliding the reduced filter over the enlarged receptive field and applying the convolution during sliding.

After the loop is terminated, an optional step of outputting the result of all convolution operations for each patch can be carried out.

According to an example embodiment of the present invention, it is provided that the step of initializing the locality-sensitive hashing is carried out depending on an estimated number of hyperplanes for the locality-sensitive hashing, wherein the number is estimated depending on a computational resource of the computation unit on which the convolutional layer is carried out. Preferably, the number of hyperplanes is at least 20 and shall not exceed 60, preferably shall not exceed 40.

In a further aspect of the present invention, a computer-implemented method for using the neural network with the efficient convolution according to the first aspect of the invention as classifier for classifying sensor signals is proposed. The classifier is adopted with the method according to any one of the preceding aspects of the present inventions, comprising the steps of: receiving a sensor signal comprising data from the imagining sensor, determining an input signal which depends on said sensor signal, and feeding said input signal into said classifier to obtain an output signal that characterizes a classification of said input signal.

In a further aspect of the present invention, a control system for operating the actuator is provided. The control system comprising the classifier adopted according to any of the preceding aspects of the present invention and being configured to operate said actuator in accordance with an output of said classifier.

Example embodiments of the present invention will be discussed with reference to the following figures in more detail.

### BRIEF DESCRIPTION OF THE DRAWINGS

FIG. 1 shows a schematic flow diagram of an example embodiment of the present invention.

FIG. 2 shows a schematic overview of a framework of an embodiment of the present invention.

### DETAILED DESCRIPTION OF EXAMPLE EMBODIMENTS

The present invention provides a dynamic/online pruning scheme for convolutional neural networks (CNNs), such as ResNets or VGGs. CNNs are a class of (deep) neural networks, often employed for computer vision or image processing tasks. They are characterized by the use of convolutional filters, which perform (discrete) convolutions on the input signal in a sliding window manner to produce an output signal. Multiple convolutional filters can be contained in one convolutional module. Many such modules are then concatenated together, often with other modules such as Batch Normalization or activation functions (e.g. ReLU) to form a convolutional layer. Finally, a typical CNN like ResNet often uses multiple convolutional layers of different sizes to perform tasks like image classification or, when used as a “backbone” (i.e. preprocessing step)/feature extractor, also semantic segmentation or object detection. In one aspect of the invention, a method is described to prune channels (i.e. “slices”) of the input signals given to a convolutional module, thus reducing overall computational cost of processing the input while retaining high performance.

The main aspect of the present invention revolves around reducing unnecessary computations when performing the convolution operation on high-dimensional inputs, as the input signal often contains redundancies in the form of similar channels or slices within the channels. However, in a regular convolution operation, all channels are treated as equally important, resulting in high computational cost. The invention uses a scheme referred to as in the following locality sensitive hashing to detect these redundancies. It is an approximate nearest neighbor search method which can cluster input slices together based on their similarity. Given this clustering of channels, one can merge/reduce the redundant information in the input signal to a minimum by performing cheap operations such as taking the mean or the sum of these channels. Afterwards, one can apply the convolution on the reduced input. While performing the hashing and merging steps incurs additional cost to the overall module, these operations combined with the convolution on the reduced input are still significantly cheaper then performing the regular convolution on an input with redundancies. This behavior mainly stems from the fact that the convolution operation itself is expensive, performing many element-wise multiplications and additions. Furthermore, this convolution is repeated for every convolutional filter in one convolutional module. For this reason, filtering out redundancies and computing their mean/sum beforehand results in a small “one-time cost” that in turn drastically reduces the following repeated cost of computing convolutions.

The present invention has direct applications in autonomous driving, robotics and other resource-constrained mobile application areas of convolutional neural networks. In particular, for the processing of image sensor data, the size and computational complexity of AI models remains a problem. CNNs are often too large to fit onto mobile hardware in terms of memory and latency requirements. As model FLOPs are a direct measurement of how many computations need to be performed for the model to produce an output given an input, a reduction in FLOPs offers the potential for savings in terms of runtime (latency) and energy requirements on mobile devices.

More specifically, one could imagine applications in terms of a system-on-chip video/image processing sensor, where available computational resources are limited. Furthermore, mobile applications often require available resources to be shared among multiple compute-intensive modules. This can put limits on the maximum energy consumption or latency a model is allowed to have. The present invention offers potential to reduce both by reducing computational cost. Furthermore, other methods can be infeasible for usage due to data dependencies or retraining requirements. For example, models that are continuously trained on streams of video data cannot simply be retrained from scratch or easily fine-tuned to achieve a reduction in computational cost by pruning. Other models may also have expensive training procedures, which would, in the worst case, need to be repeated to successfully prune them. Our method bypasses these restrictions and offers substantial FLOPs reduction.

Preferably, the present invention is used for analyzing data obtained from a sensor. The sensor may determine measurements of the environment in the form of sensor signals, which may be given by, e.g. digital images, e.g. video, radar, LiDAR, ultrasonic, motion, thermal images.

More preferably, the present invention is used for classifying the sensor data, detecting the presence of objects in the sensor data or performing a semantic segmentation on the sensor data, e.g. regarding traffic signs, road surfaces, pedestrians and/or vehicles. This is carried out based on low-level features (e.g. edges or pixel attributes for images).

In the following, a detailed description of the present invention for channel pruning in convolutional neural networks is given. The approach is described for an arbitrary convolutional module, as it can be applied to a convolution module in a given network. Note the case distinction between using a convolution with filters of kernel size k>=2 and filters of kernel size k=1, also called 1×1 convolutions or pointwise convolutions.

When the proposed convolutional module is initialized, we construct hash functions through generating a set of L random hyperplanes through their normal vectors. The vectors are generated in a sparse way to save computational cost in the hashing process.

The locality-sensitive hashing process is advantageous as it acts as a computationally inexpensive way to perform approximate nearest neighbor search. We are using the “random projections” scheme, which is particularly well-suited to the usage in convolutional layers. However, alternatives such as MinHash or Winner Takes All Hash (WTA Hash) might also be a viable choice.

Case k>=2:

When using convolutional filters with kernel size k>=2, we aim to prune larger patches instead of smaller context window observed by the convolutional filter at every filter position p in the sliding window process. For this, we hash a representation of each channel of the given patch in a locality-sensitive way, essentially clustering similar channels in the hash buckets. We are then able to merge all approximately similar channels together, such that the channel dimension, or depth, of the input signal (patch) is reduced. Similarly, we merge the corresponding channels of all convolutional filters in this module on the fly, also reducing their depth by the same amount. Note that the degree of reduction of depth is dependent on the input signal, allowing for high compression ratios when the input is highly redundant. Furthermore, the compression ratio can also vary between filter position, such that redundant image regions achieve particularly high compression.

While the merging operation itself is essential to our method, the specific choice of merging operation may be altered. Instead of taking the mean of input channels, one may also try computing the element-wise maximum or median.

Finally, we are able to perform a regular convolution operation between the reduced input and the reduced filters, producing a regular-sized output that can be immediately used by the next module in the chain without any alterations.

Case k=1:

When using pointwise convolutions, the hashing process needs to be altered to function correctly. For this reason, we rasterize the input into non-overlapping patches of size 3×3 in the spatial dimension and zero-pad if necessary. Then, each patch can be hashed similar to the case k>=2 above, resulting in a reduction of the channel dimension of the input and the filters. Inside each reduced patch, we can perform the 1×1 convolution with filters that are merged to the same depth as the input patch by merging corresponding channels. The output again retains the shape that the underlying convolutional module would regularly produce.

Locality sensitive hashing is a popular approach for approximate fast nearest neighbor search in high-dimensional spaces. A hash function h: R^{d}→N is locality-sensitive if similar vectors in the input domain x, y∈R^{d} receive the same hash codes h(x)=h(y) with high probability. This is in contrast to regular hashing schemes which try to reduce hash collisions to a minimum, widely scattering the input data across their hash buckets. More formally, we require a measure of similarity on the input space and an adequate hash function h. A particularly suitable measure for use in convolutional architectures is the cosine similarity, as convolving the (approximately) normalized kernel with the normalized input is equivalent to computing their cosine similarity.

One preferred family of hash functions that groups input data by cosine similarity is given by random projections (RP). These functions partition the high-dimensional input space through L random hyperplanes, such that each input vector can be assigned to exactly one section of this partitioning, called a hash bucket. Determining the position of an input x∈R^{d} relative to all L hyperplanes is done by taking the dot product with their normal vectors vₗ∈R^{d}, l∈{1, 2, . . . , L}, whose entries are drawn from a standard normal distribution N(0,1).

By defining:

$${h}_{l} : {R}^{d} \to \{ 0 , 1 \} , {h}_{l} ( x ) := \{ \begin{matrix}1 , & if {v}_{l} \cdot x > 0 , \\ 2 , & else ,\end{matrix} \qquad ( eq . 1 )$$

we get a binary information representing to which side of the l-th hyperplane our input x lies. The hyperparameter L governs the discriminative power of this method, dividing the input space R^{d} into a total of 2^{L} distinct regions, or hash buckets. By concatenating all individual functions hₗ, we receive the RP hash function:

$$h : {R}^{d} \to {\{ 0 , 1 \}}^{L} , h ( x ) = ( {h}_{1} ( x ) , … , {h}_{L} ( x ) ) \qquad ( eq . 2 )$$

Note that h(x) is an L-bit binary code, acting as an identifier of exactly one of the 2^{L} hash buckets. Equivalently, we can transform this code into an integer, effectively labeling the hash buckets from 0 to 2^{L}−1:

$$h : {R}^{d} \to \{ 0 , 1 , … , {2}^{L} - 1 \} , h ( x ) = {2}^{L - 1} {h}_{L} ( x ) + … + {2}^{0} {h}_{1} ( x ) \qquad ( eq . 3 )$$

While LSH already reduces computational complexity drastically compared to exact nearest neighbor search, the binary code generation still requires L*d multiplications and L*(d−1) additions per input. To further decrease the cost of this operation, one can employ the method presented in Ping Li, Trevor Hastie, and Kenneth Church; “Very Sparse Random Projections;” volume 2006, pp. 287-296, 08 2006. doi: 10.1145/1150402.1150436. Instead of using standard normally distributed vectors vₗ, one may alternatively use very sparse vectors vₗ, containing only elements from the set {1, 0, −1}. Given a targeted degree of sparsity s∈(0,1), the hyperplane normal vectors vₗ are constructed randomly such that only an expected number of s non-zero entries appear. Suppose we choose s=⅓, then our normal vectors vₗ contain just d/3 non-zero entries. As the remaining entries are chosen to be either −1 or 1, the dot product computation reduces to L*(d/3−1) additions and 0 multiplications. This allows us to trade expensive multiplication operations for cheap additions.

After establishing LSH via sparse random projections as a computationally cheap way to find approximate nearest neighbors in high-dimensional spaces, we now aim to leverage this method as a means of finding redundancies in the channel dimension of latent feature maps in convolutional models.

Formally, a convolutional layer can be described by sliding multiple learned filters Fⱼ∈R^{c}^{ᵢₙ}^{×k×k}, j∈{1, 2, . . . , cₒᵤₜ} over the (padded) input feature map X∈R^{c}^{ᵢₙ}^{×h×w} and computing the discrete convolution at every point. Here, k is the kernel size, h and w denote the spatial dimensions of the input and cᵢₙ, cₒᵤₜ describe the input and output channel dimensions, respectively.

For any patch p and the corresponding k+b×k+b window of the input X^{(p)}∈R^{c}^{ᵢₙ}^{×k×b×k×b}, many channels contain similar information. Despite this, e.g., all channels Xᵢ^{(p)}∈R^{k+2×k+2}, i∈{1, 2, . . . , cᵢₙ} are convolved with their corresponding sliding kernels to produce an output, ignoring the existing redundancies.

We challenge this design choice and instead leverage redundant channels to save computations in the convolution operation. To retrieve these channels, we propose to utilize the above LSH scheme. More concretely, to group similar channels, we flatten all Xᵢ^{(p)} into (k+2)²-dimensional vectors. This set of vectors is then centered by the mean along the channel dimension and hashed by h, giving us a total of cᵢₙ hash codes.

We then check which hash code appears more than once, as all elements that appear in the same bucket are determined to be approximately similar by the LSH scheme. Consequently, grouping the vector representations of Xᵢ^{(p)} by their hash code, we receive sets of redundant feature map channels. These can then be merged to reduce computational complexity of the convolution module.

In particular, note that our RP LSH approach is invariant to the scaling of a given input vector. This means that k+b×k+b input channels of the same structure, but with different activation intensities, still land in the same hash bucket, effectively finding even more redundancies in the channel dimension.

After clustering redundant input channels Xᵢ^{(p)} into hash buckets, we can utilize this grouping to save FLOPs when performing the convolution operation.

To avoid repeated computations on nearly similar channels, we dynamically reduce the size of each input context window by merging channels in the same hash bucket. The merging operation is performed by taking the mean of all channels in one bucket. As a result, the number of remaining input channels is reduced to cᵢₙ_{_{reduced}}<cᵢₙ. This lets us define a compression ratio:

$$r := 1 - \frac{{c}_{{in}_{reduced}}}{{c}_{in}} ∈ ( 0 , 1 ) ,$$

determining the relative reduction in feature map depth. Note that this ratio is dependent on the amount of redundancies in the input feature map X at filter position p. This enables us to prune channels dynamically, allowing for different compression ratios across images and even in different regions of the same input.

In a similar manner to the reduction of the input feature map depth, we merge the corresponding channels of the convolutional filters Fₗ. However, instead of also hashing the filter channels, we can simply merge those channels that correspond to the collapsed input channels. This merging step is done on the fly at every filter position p, retaining the original weights for the next filter position. As a result, the one-to-one correspondence of channels is left intact, while also reducing the filter depth to cᵢₙ_{_{reduced}}. Note that, instead of taking the mean of filter channels, we simply add them together. In this way, a convolution between reduced input window and reduced filter retains the same output intensity as the original convolution, while requiring much fewer computations.

The method can be defined by a pseudo code as follows:

Input: Feature map X ϵ [symbol] [symbol] ⁱⁿ^{^{×H×W}}, Filters F ϵ [symbol] [symbol] ^{out}^{^{×}} [symbol] ⁱⁿ^{^{×K×K}}
Output:Y ϵ [symbol] [symbol] ^{out}^{^{×H×W}}
Initialize: Hash Function h : [symbol] ^{(K+2)}^{²} → {0, 1, . . . , 2^{L} − 1}

| | | |
|---|---|---|
| 1: | for every patch p do | |
| 2: | HashCodes = [ ] | [symbol] Create empty list of hash codes |
| 3: | for i = 1, 2, . . . , [symbol] ᵢₙ do | |
| 4: | x^{(p)}ᵢ = Center(Flatten(X^{(p}₎₄)) | [symbol] Generate centered and flatten representation |
| 5: | HashCodes.append(h(x^{(p)}₄)) | [symbol] Hash input representation and append code |
| 6: | end for | |
| 7: | \tilde{X}^{(p)} = MergeInput(X^{(p)}, HashCodes) | [symbol] Compute mean of channels in one bucket |
| 8: | \tilde{F} = MergeFilters(F, HashCodes) | [symbol] Sum corresponding filter channels |
| 9: | Y^{(p)} = \tilde{X}^{(p)} » \tilde{F} | |
| 10: | end for | |
| 11: | return Y | |

Although the hashing of input channels and performing merging operations creates additional computational cost, the overall savings on computing the convolution operation with reduced channel dimension outweigh the added overhead.

The presented method above acts as a direct plug and play replacement for any regular convolution module in a CNN. It features just one hyperparameter L, governing the amount of hyperplanes used in the LSH scheme. Its value directly determines a trade-off between the compression ratio and retained accuracy. When L is low, the random projections only coarsely separate input channels into groups. While this results in high compression ratios, the resulting output feature map may differ substantially from that of the full convolution operation, leading to an overall reduction in model performance. In contrast, when L is large, we retain almost full model performance at the expense of lower compression ratios. Therefore, the choice of L allows for generating multiple model variants from one underlying base model, e.g. either focusing on low FLOPs or high performance.

The hyperparameter L determining the number of hyperplanes used in the hashing scheme directly acts as a controller for the accuracy/FLOPs trade-off. It can be individually tuned at every point in the network as to find the desired balance between model and hardware performance.

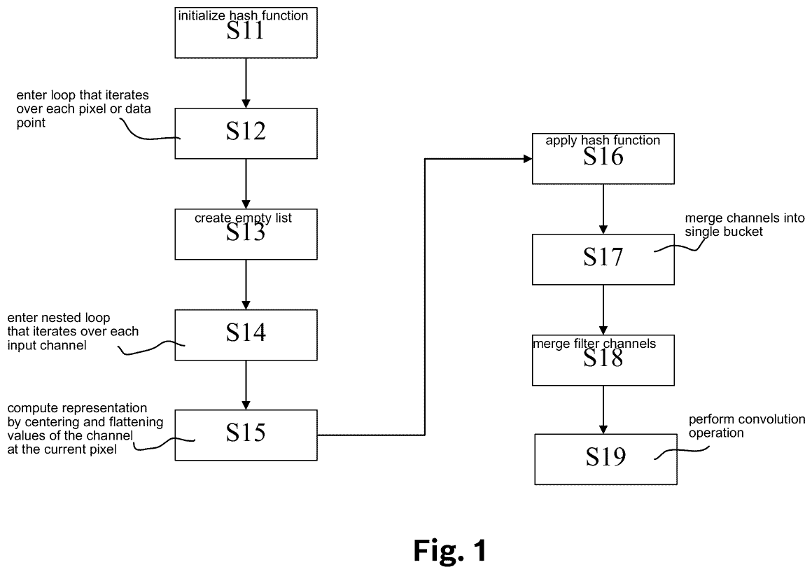

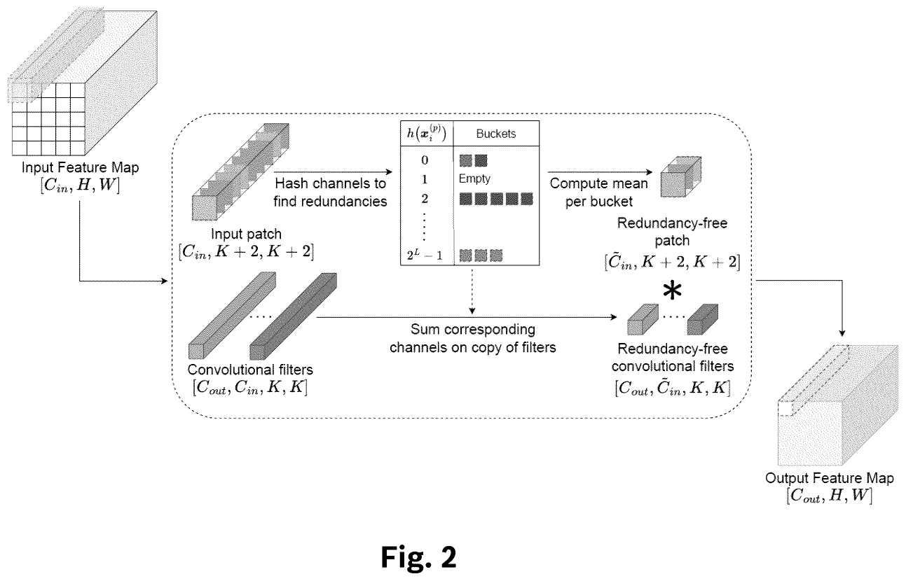

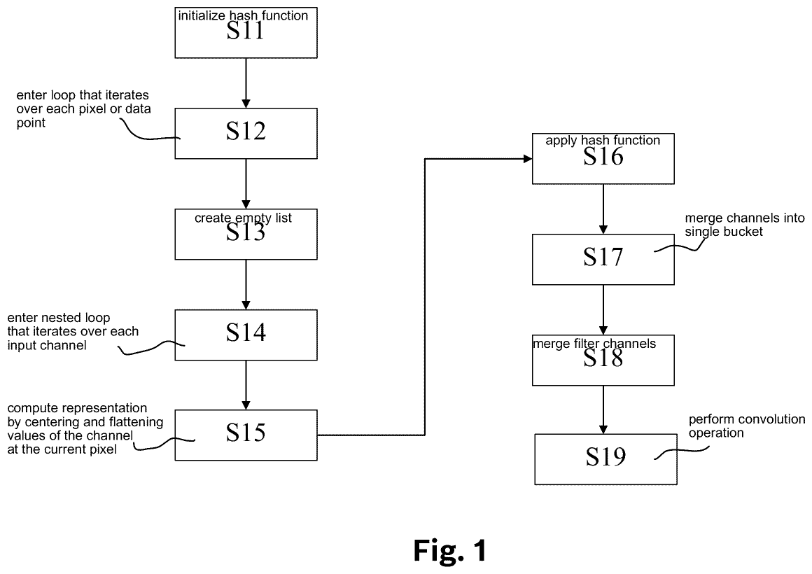

FIG. 1, in particular together with the above pseudo code, shows an algorithm of the described approach above comprising a series of steps for processing input data of a convolutional layer of a CNN by hashing and merging channels as well as merging filter kernels according to the merging of the channels before performing convolutions to generate the output tensor of, e.g., the convolutional layer.

The algorithm starts with step S11 ‘Initialize Hash Function’, which initialize a hash function h. This function will be used to hash representations of data. Preferred choices of different hash function have been discussed above.

In the subsequent Step S12, the algorithm enters a loop that iterates over each pixel in the input image or data point of the feature map of the convolutional layer. The loop runs over the patches p of the input image or feature.

In the subsequent Step S13, inside said loop, an empty list referred to as HashCodes is created. This list is suited to store hash codes generated for each channel of the input data at the current pixel or data point.

In the subsequent Step S14, inside said loop, there is another nested loop that iterates over each input channel i (from 1 to cᵢₙ).

In the subsequent Step S15, in the nested loop for each input channel, a representation xᵢ is computed by centering and flattening the values of the channel at the current pixel p. This is done using the ‘Center’ and ‘Flatten’ operations. The result is a flattened vector.

In the subsequent Step S16, the algorithm then applies the hash function ƒ to the generated representation xᵢ, producing a hash code. This hash code is appended to the HashCodes list.

In the subsequent Step S17, after processing all input channels at the current pixel, the algorithm merges these channels into a single bucket. This means that the algorithm combines the values of all input channels at this pixel according to the computed hash codes. The result is stored as X_{reduced}^{(p)}.

In the subsequent Step S18, the algorithm merges the corresponding filter channels from the set of filters F based on the same hash codes. The result is stored as F_{reduced}. The merging of the filters is similarly carried out like the merging of the channels, wherein instead of averaging the channels in a given bucket, the filters of the corresponding bucket are summed up.

In the subsequent Step S19, with the reduced input X_{reduced}^{(p)} and reduced filters F_{reduced}, the algorithm performs a convolution operation (e.g., a standard convolution) to compute the output Y^{(p)} at the current pixel on the reduces input by a convolution with the reduced filter. Due to both compressed data representations of the compressed filter and compressed window, significantly less convolution operations have to be carried out.

Finally, the algorithm returns the output tensor Y, which has the same dimensions as the input but with a reduced number of channels (cₒᵤₜ).

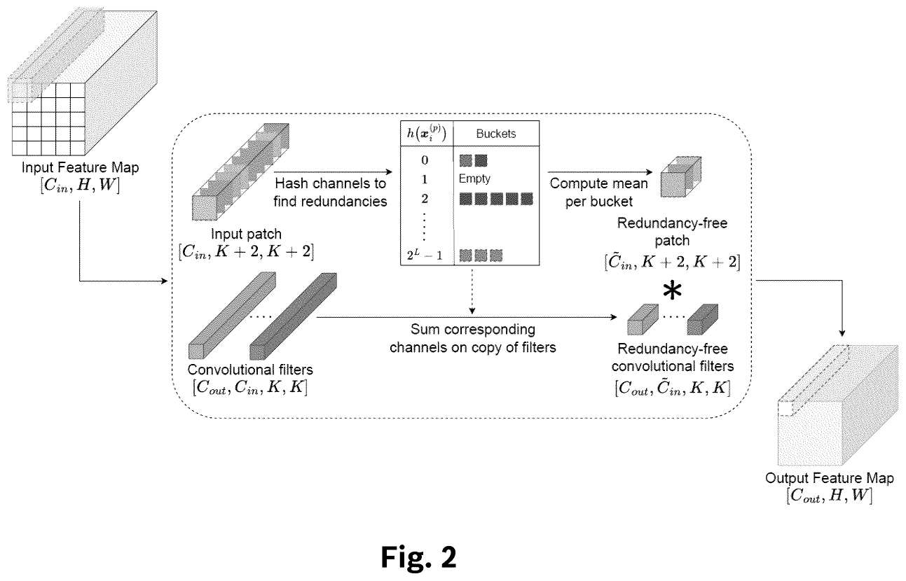

FIG. 2 shows an overview of the reduction of the context window and filters. Each patch of the input feature map is processed to find redundant channels. Detected redundancies are then merged together, reducing the depth of the sliding window and all convolutional filters.

What is claimed is:

1. A computer-implemented method of efficiently calculating convolutions of a convolutional layer of a neural network, the method comprising the following steps:
receiving a tensor of input data to be processed by the convolutional layer and at least one filter of the convolutional layer, wherein the filter includes several (cᵢₙ) filter kernels;
initializing a locality-sensitive hashing function; and
repeating the following steps for a plurality of patches of the tensor:
slicing a current patch into a series (cᵢₙ) of matrices,
applying the locality-sensitive hashing to each of the matrices to determine a hash representation for each matrix,
merging the matrixes with the same hash representation to a new matrix,
creating a reduced sub-tensor by arranging the merged matrices in a series,
merging the filter kernels in the same order as the matrices have been merged, and
convolving the reduced sub-tensor with the merged filter.

2. The method of claim 1, wherein the step of initializing the locality-sensitive hashing is carried out depending on an estimated number of hyperplanes for the locality-sensitive hashing, wherein the number is estimated depending on a computational resource of the computation unit on which the convolution layer, is carried out.

3. The method of claim 1, wherein the tensor is an image to be processed by the neural network or a feature map of a previous layer of the convolutional layer.

4. The method of claim 1, wherein the neural network classifies its input based on the convoluted reduced sub-tensor with the merged filter.

5. The method of claim 1, wherein the convolutional filter has a size of cᵢₙ×k×k, wherein k≥1 and k×k represents the kernel size.

6. The method of claim 1, wherein the merging of the matrices is performed by averaging over the matrices with the same hash representation or by taking a median or an element-wise maximum of the matrices with the same hash representation.

7. The method of claim 1, wherein the merging of the filter kernels is carried out by summing up the filter kernels corresponding to the merged matrices with the same hash representations.

8. The method of claim 1, wherein a receptive field is synthetically enlarged by at least one entry along each dimension.

9. A non-transitory machine-readable storage medium on which is stored a computer program for efficiently calculating convolutions of a convolutional layer of a neural network, the computer program, when executed by a processor, causing the processor to perform the following steps:
receiving a tensor of input data to be processed by the convolutional layer and at least one filter of the convolutional layer, wherein the filter includes several filter kernels;
initializing a locality-sensitive hashing function; and
repeating the following steps for a plurality of patches of the tensor:
slicing a current patch into a series (cᵢₙ) of matrices,
applying the locality-sensitive hashing to each of the matrices to determine a hash representation for each matrix,
merging the matrixes with the same hash representation to a new matrix,
creating a reduced sub-tensor by arranging the merged matrices in a series,
merging the filter kernels in the same order as the matrices have been merged, and
convolving the reduced sub-tensor with the merged filter.

10. A system that is configured to efficiently calculate convolutions of a convolutional layer of a neural network, the system configured to:
receiving a tensor of input data to be processed by the convolutional layer and at least one filter of the convolutional layer, wherein the filter includes several filter kernels;
initialize a locality-sensitive hashing function; and
repeat the following steps for a plurality of patches of the tensor:
slicing a current patch into a series (cᵢₙ) of matrices,
applying the locality-sensitive hashing to each of the matrices to determine a hash representation for each matrix,
merging the matrixes with the same hash representation to a new matrix,
creating a reduced sub-tensor by arranging the merged matrices in a series,
merging the filter kernels in the same order as the matrices have been merged, and
convolving the reduced sub-tensor with the merged filter.
